(19) United States
(12) Patent Application Publication
(10) Pub. No.: US 2009/0124737 A1
(43) Pub. Date: May 14, 2009

(54) ACRYLIC PLASTISOL VISCOSITY REDUCERS

(75) Inventors: Mark Stephen Holt, Huntersville, NC (US); Martin James Stimpson, Lockeridge (GB); David Justin Olsen, Kingsport, TN (US)

Correspondence Address: BRETT L. NELSON;EASTMAN CHEMICAL COMPANY, 100 NORTH EASTMAN ROAD, KINGSPORT, TN, 37660-5075, US

(73) Assignee: EASTMAN CHEMICAL COMPANY, Kingsport, TN (US)

(21) Appl. No.: 11/938,515

(22) Filed: Nov. 12, 2007

(51) Int. Cl. C08K 5/095

(52) U.S. Cl. 524/284; 524/300

(57) ABSTRACT

Low VOC viscosity reducer (LVVR) compounds useful for reducing the viscosity of plastisol compositions. The acrylic plastisol compositions are combined with a viscosity reducing compound which is derived from esters of compounds such as 2,2,4-trimethyl-1,3-pentane diol (TMPD).

### FIELD OF THE INVENTION

The present invention relates to acrylic plastisols which include esters of compounds such as 2,2,4-trimethyl-1,3-pentane diol (TMPD) for reducing the viscosity of the plastisols, and methods of preparing the plastisol compositions.

### BACKGROUND OF THE INVENTION

Acrylic plastisols are used in a variety of useful applications such as screen inks, dental applications, wall covering, and flooring. Acrylic plastisols are produced from high molecular weight acrylic resins which results in a high viscosity for the system. In some cases, the high viscosity does not allow use of acrylic plastisols for a particular system. Additionally, the viscosity stability of these systems is generally not very good.

In addition, in the market of acrylic plastisol inks suitable for printing onto clothing (e.g. T-shirts), there is a need for inks which are free of both PVC and phthalates. This is because PVC and phthalate free inks are considered more environmentally friendly. One such ink is based on an acrylic resin (Degalan 4899F from Degussa) and the plasticizer Benzoflex 354 (the benzoic acid diester of 2,2,4-trimethyl-1,3-pentanediol from Velsicol). However, this plasticizer is considerably more expensive than a traditional phthalate product.

The present invention offers cost and performance benefits over current acrylic palsticisers while also producing plastisols with lower and more useful viscosities and improved viscosity stability.

### BRIEF SUMMARY OF THE INVENTION

A first embodiment according to the present invention concerns an acrylic plastisol composition comprising an acrylic resin, a plasticizer, and a viscosity reducing compound, wherein said compound is an ester derived from the reaction of: a) 2,2,4-trimethyl-1,3-pentane diol (TMPD), 2,2,4-trimethyl-1,3-pentanediol monoisobutyrate (TXOL), Triethylene Glycol (TEG), diethylene glycol (DEG), polyglycol (PG), Tetra ethylene glycol, 2-ethylhexanol, isononyl alcohol, butanol, or mixtures thereof; and b) a carboxylic acid, a fatty acid, or mixtures thereof.

Another embodiment concerns a method of producing an acrylic plastisol composition having a reduced viscosity. The method comprises contacting: a) an acrylic plastisol; and b) a viscosity reducing compound wherein said compound is an ester derived from the reaction of: i) 2,2,4-trimethyl-1,3-pentane diol (TMPD), 2,2,4-trimethyl-1,3-pentanediol monoisobutyrate (TXOL), Triethylene Glycol (TEG), diethylene glycol (DEG), polyglycol (PG), Tetra ethylene glycol, 2-ethylhexanol, isononyl alcohol, butanol, or mixtures thereof; and ii) a carboxylic acid, a fatty acid, or mixtures thereof.

Yet another embodiment concerns an article of manufacture comprising the acrylic plastisol composition.

### BRIEF DESCRIPTION OF THE DRAWINGS

FIG. 1 shows gelation profiles of various plastisol formulations;

FIG. 2 shows initial viscosity profiles of the various plastisol formulations;

FIG. 3 shows viscosity profiles of the various plastisol formulations after one day;

FIG. 4 shows viscosity profiles of the various plastisol formulations after two days;

FIG. 5 shows viscosity profiles of the various plastisol formulations after seven days; and

FIG. 6 shows the viscosity trends of the various plastisol formulations over a seven day period.

### DETAILED DESCRIPTION

This invention relates to low volatile organic content (VOC) compositions, such as acrylic plastisols, that include low VOC viscosity reducing (LVVR) compounds as well as methods of making the VOC composition having reduced viscosity. The LVVR compounds are esters of compounds such as 2,2,4-trimethyl-1,3-pentane diol (TMPD). Additional LVVR compounds include esters of compounds such as 2,2,4-trimethyl-1,3-pentanediol monoisobutyrate (TXOL or TEXANOL®); Triethylene Glycol (TEG); diethylene glycol (DEG); polyglycol (PG); Tetra ethylene glycol; 2-ethylhexanol; isononyl alcohol; and butanol,

The LVVR compounds according to the present invention can also be derived from the reaction of at least one of the compounds listed above with at least one of carboxylic acids, such as 2-ethylhexanoic acid, and fatty acids. The reaction results in esters of the compounds listed above having the hydroxyl group(s) replaced with the carboxylic acids and/or fatty acids.

Carboxylic acids useful in the present invention typically have an average carbon chain length of C-6 or higher, for example acids and iso-acids from C-6 up to about C-13. Alternatively, the carboxylic acids or fatty acids used to modify the compounds should result in a modified compounds having two ester groups in which the total carbon count of the two ester groups is in the range of about C-10 to about C-20 or from about C-12 to C-18. For example, if one of the two hydroxyl groups on the TMPD has been replaced with a carboxylic acid or fatty acid having 4 carbons, then the other hydroxyl group is replaced by a carboxylic acid or fatty acid having between 6 and 20 carbons.

A non-exhaustive list of suitable carboxylic acids includes 2-ethylhexanoic acid, caproic acid, heptoic acid, caprylic acid, nananoic acid, capric acid, undecanoic acid, lauric acid, tridecanoic acid, myristic acid, pentadecanoic acid, palmytic acid, heptadecanoic acid, adipic acid, trimellitic acid, benzoic acid, and isomers thereof.

Suitable fatty acids include stearic acid, oleic acid, linoleic acid, linolenic acid, gadoleic acid, vaccenic acid, petroselinic acid, arachidonic acid.

The various viscosity reducing compounds can be added to the plastisols at a range of from about 1.0% to about 30%, or at a range of from about 2.0% to about 20%, or even at a range of from about 3.0% to about 15% by weight.

Examples compounds useful in the present invention includes TXOL 2-ethylhexanoate, TMPD bis-2-ethylhexanoate, TMPD mono 2-ethylhexanoate, TXOL monolaurate, TEG 2-ethylhexanoate, TEG di-nonate, TEG di-decanate, TEG di-acetate, DEG 2-ethylhexanoate, DEG di-acetate, DEG di-stearate, DEG mono-stearate, DEG ethyl-ether-acetate, TEG benzyl-ether-acetate, DEG butyl-ether-acetate, PG mpnp-stearate, tetra EG 2-ethylhexanoate, DOA, DINA, butyl octanoate, TOTM, octyl benzoate, and mixtures thereof.

These compounds can be used to produce acrylic plastisols with low initial viscosity and excellent viscosity stability. They are high boiling materials and allow the plastisol user to operate a low VOC process. In addition, the low volatility produces more finished product per batch because fewer raw materials are lost to the atmosphere within the manufacturing process resulting in a more efficient process.

The present viscosity reducing compounds may be incorporated in the acrylic resin, along with or without other additions, by any suitable process such as, mixing or kneading of the ingredients. A desirable procedure involves forming an acrylic resin dispersion which can be cast in a film or thicker body, and then heated to form a homogeneous body of plasticized resin. Such dispersions are suspensions of acrylic resin particles in nonaqueous liquids including the plasticizer which do not dissolve the resin at ordinary temperatures but do at elevated temperatures. If the liquid phase consists only of plasticizer, the dispersion is often termed as “plastisol,” whereas if the dispersing liquid also contains volatile organic solvents or organic components which evaporate upon heating, the dispersion is often termed as “organosol.” Both plastisols and organosols may include other additives, including stabilizers, normally used in acrylic resin compositions. The term “plastisol” as used herein is intended to include both plastisols and organosols.

The viscosity reducing compounds according to this invention may be added at any time and in any convenient manner to the acrylic plastisol. If desired, the acrylic plastisol and viscosity reducing compounds may be mixed simultaneously, for example, conventional mixing or blending equipment.

The plastisols according to this invention may be used to make numerous products utilizing methods known to those skilled in the art such as casting, coating, etc. For example, the plastisols can be used to make textile printing inks, gloves, sealants, adhesives, balls, toys, floor coverings, and coated fabrics.

As used throughout this application, the reference to a modified TMPD, TXOL or other molecule as the “reaction product” of specified reactants is provided as a convenient way to describe the structure of the molecule, and not as a limitation to molecules made by specific methods or using specific reactants. Thus, any molecule having the molecular structure described by reference to a reaction product, but obtained by other methods or from other reactants, will be within the meaning of “reaction product” as that term is used throughout this application.

The following examples are submitted for a better understanding of the invention.

### EXAMPLES

The basic formulation used Degalan 4899F as the acrylic and the mixing ratio was 57:43 of plasticizer to acrylic. This formulation was used to measure viscosity, viscosity stability and gelation profiles.

### Blending Method

The acrylic resin and plasticizer was initially mixed by hand using a spatula. It was then mixed on a Vacuumat mixer at 600 rpm for 10 minutes.

### Fusing Method

The plastisol was coated onto release paper (250 microns) using a doctor blade. It was then fused in a Werner Mathis oven at 160° C. for 2 minutes. The time or temperature for fusing could not be increased due to restrictions in printing processes. The fused coating was visually evaluated to see how it compared with the standard Benzoflex 354 before any further testing was considered.

### Viscosity

The viscosity was measured using a Haake Viscotester VT550, PK 1 1·T, 23·C. The shear rate was increased from 0.1-100s·¹ over 60 seconds. The viscosity was recorded shortly after manufacture then repeated at 24H intervals up to 7 days

### Gelation

Gelation tests were made using a Haake Viscotester VT550, PK 1 1·T, 65·C, shear rate 122s·¹.

### Gelation

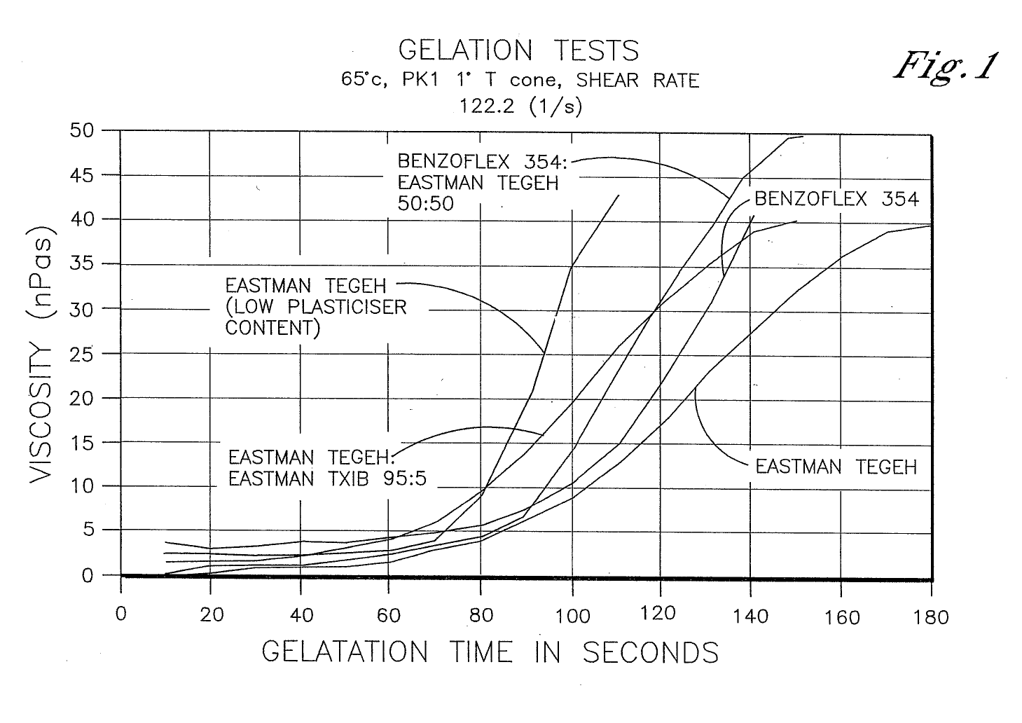

The results (as shown in FIG. 1) show that Benzoflex 354 (control) gels slightly faster than TEGEH. Blending TEGEH 50:50 with Benzoflex 354 makes it gel slightly quicker than neat Benzoflex 354. Reducing the pz:resin ratio to 50:50 with TEGEH gave the fastest gelation properties. All of these formulations appeared to fuse well after 2 minutes in the Werner Mathis oven at 1600.

### Viscosity

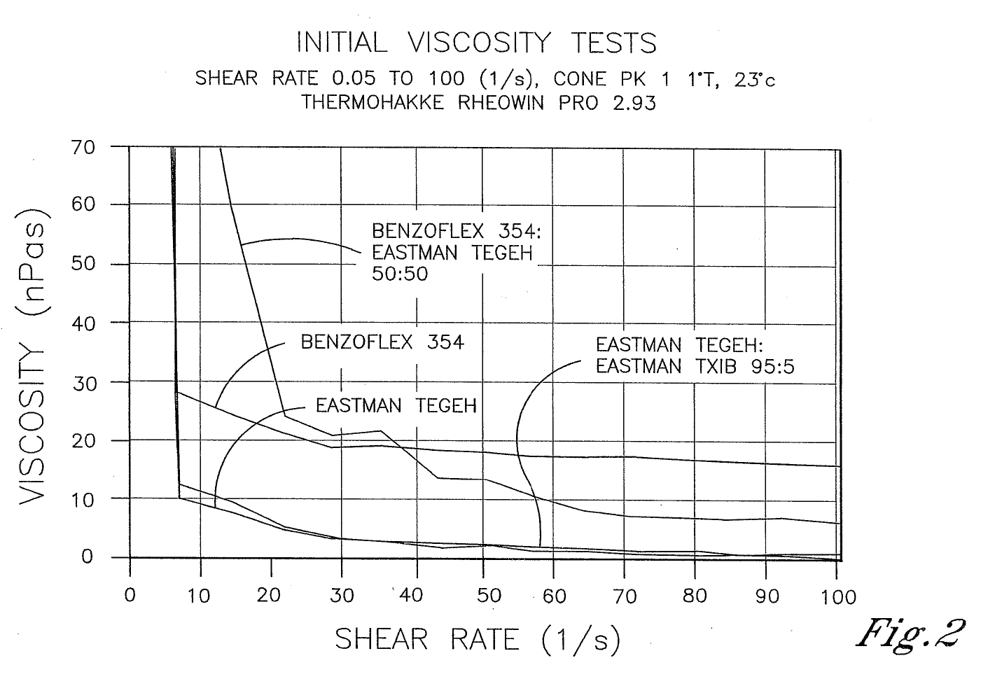

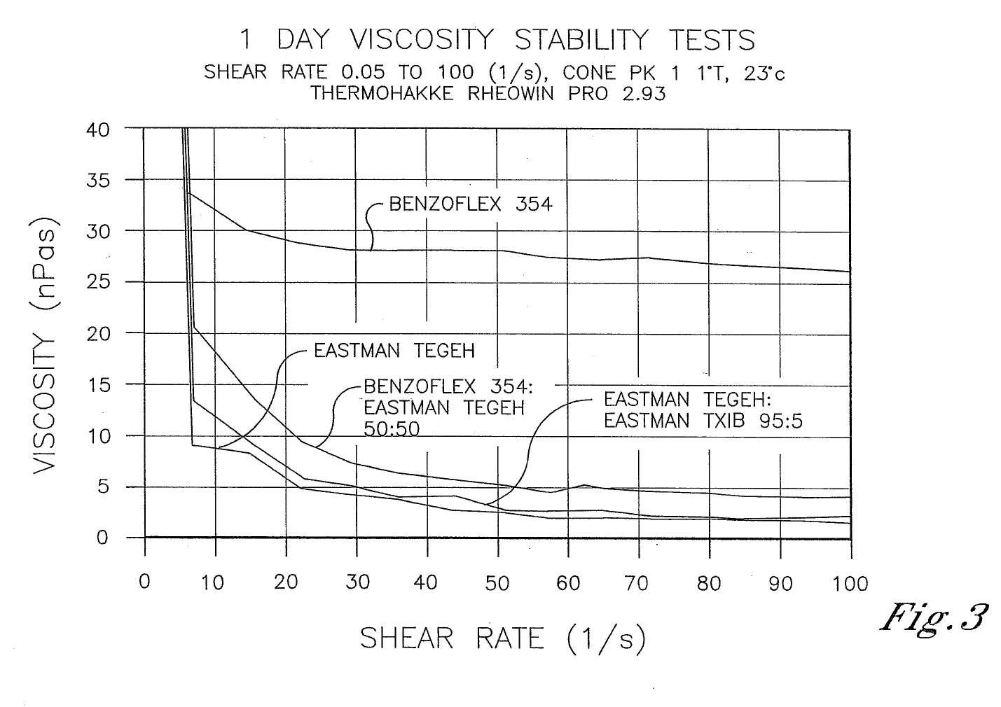

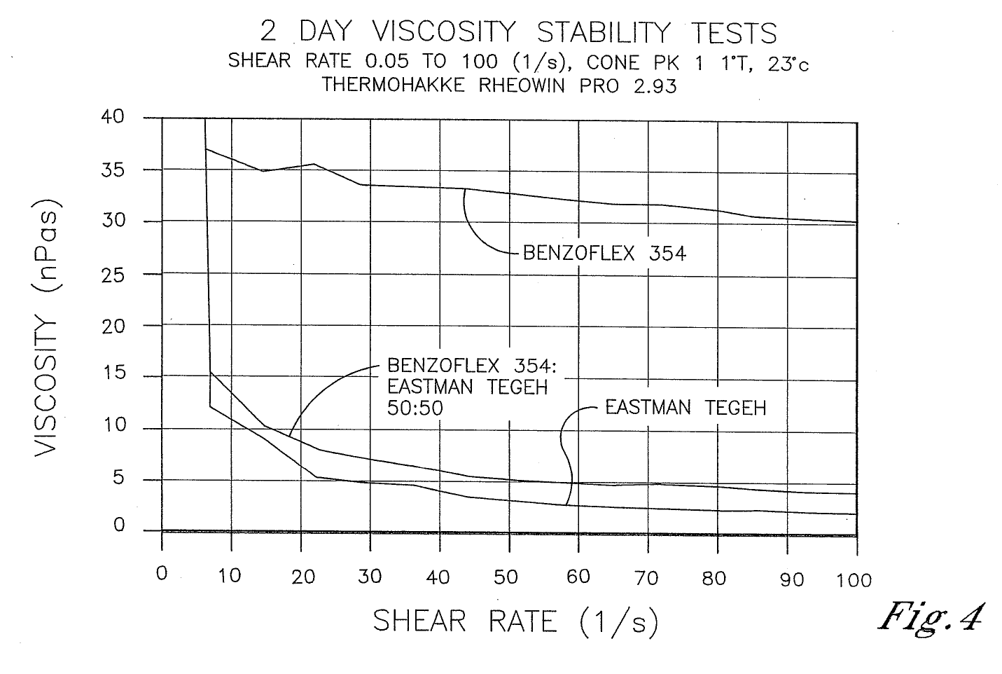

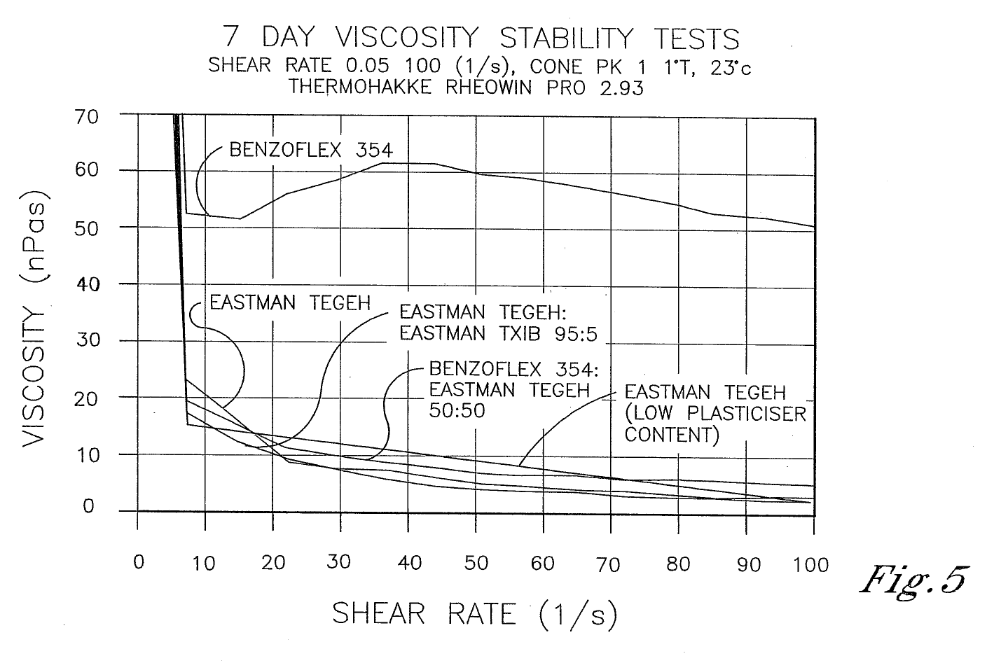

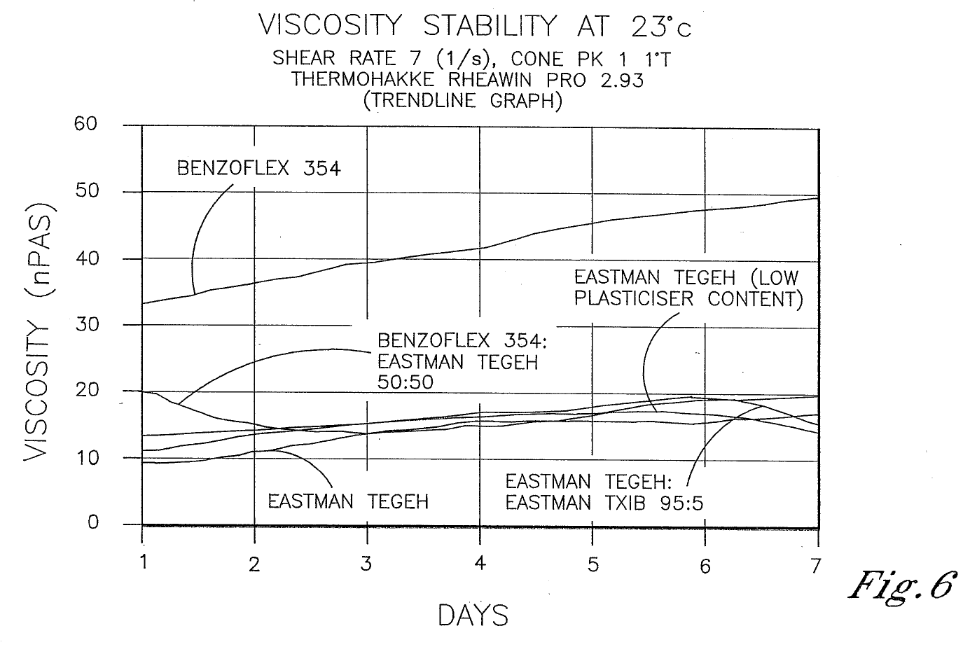

The viscosity results (as shown in FIGS. 2-6) show that formulations based on TEGEH give considerably lower viscosity plastisols compared to the control formulation based on Benzoflex 354. Reducing the plasticizer:resin ratio to 50:50 with TEGEH still gave a much lower viscosity compared to Benzoflex 354 at the 57:43 ratio. The viscosity curves over a period of 7 days showed that the formulations based on TEGEH remained considerably lower than the control based on Benzoflex 354.

The invention has been described in detail with particular reference to preferred embodiments thereof, but it will be understood that variations and modifications can be effected within the spirit and scope of the invention.

We claim:

1. An acrylic plastisol composition comprising an acrylic resin, a plasticizer, and a viscosity reducing compound, wherein said compound is an ester derived from the reaction of:
a) 2,2,4-trimethyl-1,3-pentane diol (TMPD), 2,2,4-trimethyl-1,3-pentanediol monoisobutyrate (TXOL), Triethylene Glycol (TEG), diethylene glycol (DEG), polyglycol (PG), Tetra ethylene glycol, 2-ethylhexanol, isononyl alcohol, butanol, or mixtures thereof; and
b) a carboxylic acid, a fatty acid, or mixtures thereof.

2. The composition according to claim 1, wherein the carboxylic acid or fatty acid consists of 6-13 carbon atoms.

3. The composition according to claim 2, wherein the carboxylic acid is selected from the group consisting of 2-ethylhexanoic acid, caproic acid, heptoic acid, caprylic acid, nananoic acid, capric acid, undecanoic acid, lauric acid, tridecanoic acid, myristic acid, pentadecanoic acid, palmytic acid, heptadecanoic acid, adipic acid, trimellitic acid, benzoic acid, and mixtures thereof.

4. The composition according to claim 2, wherein the fatty acid is selected from the group consisting of stearic acid, oleic acid, linoleic acid, linolenic acid, gadoleic acid, vaccenic acid, petroselinic acid, arachidonic acid.

5. The composition according to claim 1, wherein the diester has two ester groups wherein the two ester groups have a combined carbon count of from about 10-20 carbon atoms.

6. The composition according to claim 5, wherein the ester groups have a combined carbon count of from about 12-18 carbon atoms.

7. The composition according to claim 1, wherein the viscosity reducing compound is at least one of TXOL 2-ethylhexanoate, TMPD bis-2-ethylhexanoate, TMPD mono 2-ethylhexanoate and TXOL monolaurate.

8. The composition according to claim 1, wherein the viscosity reducing compound is present in an amount of from about 1.0% to about 30% by weight.

9. The composition according to claim 8, wherein the viscosity reducing compound is present in an amount of from about 2.0% to about 20% by weight.

10. The composition according to claim 9, wherein the viscosity reducing compound is present in an amount of from about 3.0% to about 15% by weight.

11. A method of producing an acrylic plastisol composition having a reduced viscosity comprising contacting:
a) an acrylic plastisol; and
b) a viscosity reducing compound wherein said compound is an ester derived from the reaction of:
i) 2,2,4-trimethyl-1,3-pentane diol (TMPD), 2,2,4-trimethyl-1,3-pentanediol monoisobutyrate (TXOL), Triethylene Glycol (TEG), diethylene glycol (DEG), polyglycol (PG), Tetra ethylene glycol, 2-ethylhexanol, isononyl alcohol, butanol, or mixtures; and
ii) a carboxylic acid, a fatty acid, or mixtures thereof.

12. The method according to claim 11, wherein the carboxylic acid or fatty acid consists of all isomers of 6-13 carbon atoms.

13. The method according to claim 12, wherein the carboxylic acid is selected from the group consisting of 2-ethylhexanoic acid, caproic acid, heptoic acid, caprylic acid, nananoic acid, capric acid, undecanoic acid, lauric acid, tridecanoic acid, myristic acid, pentadecanoic acid, palmytic acid, heptadecanoic acid, adipic acid, trimellitic acid, benzoic acid, and mixtures thereof.

14. The method according to claim 12, wherein the fatty acid is selected from the group consisting of stearic acid, oleic acid, linoleic acid, linolenic acid, gadoleic acid, vaccenic acid, petroselinic acid, arachidonic acid.

15. The method according to claim 11, wherein the diester has two ester groups wherein the two ester side chains have a combined carbon count of from about 10-20 carbon atoms.

16. The method according to claim 15, wherein the diester has two ester chains having a combined carbon count of from about 12-18 carbon atoms.

17. The method according to claim 11, wherein the viscosity reducing compound is at least one of TXOL 2-ethylhexanoate, TMPD bis-2-ethylhexanoate TMPD mono 2-ethylhexanoate, and TXOL monolaurate.

18. The method according to claim 11, wherein the viscosity reducing compound is present in an amount of from about 1.0% to about 30% by weight.

19. The method according to claim 18, wherein the viscosity reducing compound is present in an amount of from about 2.0% to about 20% by weight.

20. The method according to claim 19, wherein the viscosity reducing compound is present in an amount of from about 3.0% to about 15% by weight.

21. An article of manufacture comprising the composition according to claim 1.

22. The article of manufacture according to claim 21, wherein said article is an ink, a glove, a sealant, an adhesive, or coatings.

23. The article of manufacture according to claim 21, wherein said article is produced via casting or coating.
